(19) United States
(12) Patent Application Publication
(10) Pub. No.: US 2009/0098368 A1
(43) Pub. Date: Apr. 16, 2009

(54) USE OF COLOURED POLYMER SYSTEMS FOR PACKAGING

(75) Inventors: Wendel Wohlleben, Mannheim (DE); Reinhold J Leyrer, Dannstadt-Schauernheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/279,798

(22) PCT Filed: Feb. 15, 2007
(86) PCT No.: PCT/EP07/51462

§ 371 Date: Aug. 18, 2008

(30) Foreign Application Priority Data
Feb. 21, 2006 (EP) 06110197.8

(51) Int. Cl. B32B 33/00; C08K 5/41; B32B 27/06

(52) U.S. Cl. 428/332; 524/156; 523/201; 428/457; 428/537.5; 428/411.1; 428/327

(57) ABSTRACT

A substrate coated with a polymer system, wherein
the polymer system reflects electromagnetic radiation (Bragg reflection),
the wavelength of the reflection in the case of a strain produced by a mechanical stress is variable and
the coated substrate as a whole has such little elasticity that, on elimination of the mechanical stress, the wavelength of the Bragg reflection is changed compared with the starting state.

The invention relates to a substrate coated with a polymer system, wherein
the polymer system reflects electromagnetic radiation (Bragg reflection),
the wavelength of the reflection in the case of a strain produced by a mechanical stress is variable and
the coated substrate as a whole has such little elasticity that, on elimination of the mechanical stress, the wavelength of the Bragg reflection is changed compared with the starting state.

Aqueous polymer dispersions are economical, easily producible organic materials. DE-A 197 17 879 and DE-A 198 20 302 disclosed that special polymer dispersion are suitable for the preparation of polymer systems comprising polymer particles and a matrix, and these polymer systems exhibit Bragg reflection. Embodiments of these polymer dispersions and their use are also described in DE-A 103 21 083, DE-A 103 21 079, DE-A 103 21 084 or in the German patent applications not yet published on the date of filing of this application and having the application numbers 10 2005 023 804.1, 10 2005 023 806.8, 10 2005 023 802.5 and 10 2005 023 807.6.

The use of such polymer systems for the production of optical display elements is described in DE-A 102 29 732. In the display elements, color changes are brought about by changing the distances between the polymer particles dispersed in the matrix. The cause of the changes in distance may be, for example, the action of mechanical forces or electric fields.

Further uses of the polymer systems were an object of the present invention.

Accordingly, the coated substrates defined at the outset were found. Uses of the substrates for packaging were also found.

The polymer system is a system comprising polymer particles and a deformable material (matrix), the polymer particles being distributed in the matrix according to a defined space lattice structure.

Regarding the Polymer Particles

For the formation of a defined space lattice structure, the discrete polymer particles should be as large as possible. A measure of the uniformity of the polymer particles is the so-called polydispersity index, calculated according to the formula

P.I.=(D90−D10)/D50

wherein D90, D10 and D50 are particle diameters, which the following is true:
D90: 90% by weight of the total mass of all particles has a particle diameter less than or equal to D90
D50: 50% by weight of the total mass of all particles has a particle diameter less than or equal to D50
D10: 10% by weight of the total mass of all particles has a particle diameter less than or equal to D10.

Further explanations of the polydispersity index are to be found, for example, in DE-A 197 17 879 (in particular the drawings, page 1).

The particle size distribution can be determined in a manner known per se, for example using an analytical ultracentrifuge (W. Mächtle, Makromolekulare Chemie 185 (1984), pages 1025-1039), and the D10, D50 and D90 values can be derived therefrom and the polydispersity index determined.

The polymer particles preferably have a D50 value in the range from 0.05 to 5 mm. The polymer particles may comprise one particle type or a plurality of particle types having different D50 values, each particle type having a polydispersity index of, preferably, less than 0.6, particularly preferably less than 0.4 and very particularly preferably less than 0.3 and in particular less than 0.15.

In particular, the polymer particles consist of a single particle type. The D50 value is then preferably from 0.05 to 2 μm, particularly preferably from 100 to 400 nanometers. However, wavelengths from 50 to 1100 nanometers are also suitable.

Polymer particles which consist, for example, of 2 or 3, preferably 2, polymer types differing with respect to the D50 value can form a common lattice structure (crystallized) if the above condition with respect to the polydispersity index is fulfilled for each particle type. For example, mixtures of particle types having a D50 value from 0.3 to 1.1 μm and having a D50 value from 0.1 to 0.3 μm are suitable.

The polymer particles preferably consist of a polymer having a glass transition temperature greater than 30° C., particularly preferably greater than 50° C. and very particularly preferably greater than 70° C., in particular greater than 90° C.

The glass transition temperature can be determined by customary methods, such as differential thermal analysis or differential scanning calorimetry (cf. for example ASTM 3418/82 mid-point temperature).

The polymer preferably comprises at least 40% by weight, preferably at least 60% by weight, particularly preferably at least 80% by weight, of so-called main monomers.

The main monomers are selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and 1 or 2 double bonds or mixtures of these monomers.

Alkyl (meth)acrylates having a C1-C10-alkyl radical, such as methyl methacrylate, methyl acrylate, n-butyl acrylate, ethyl acrylate and 2-ethylhexyl acrylate, may be mentioned by way of example.

In particular, mixtures of the alkyl (meth)acrylates are also suitable.

Vinyl esters of carboxylic acids having 1 to 20 carbon atoms, are, for example, vinyl laurate, vinyl stearate, vinyl propionate, vinyl versatate and vinyl acetate.

Suitable vinylaromatic compounds are α- and p-methylstyrene, alpha-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising 1 to 4 carbon atoms are preferred.

Butadiene, isoprene and chloroprene may be mentioned as hydrocarbons having 2 to 8 carbon atoms and one or two olefinic double bonds and, for example, ethylene or propylene as those having one double bond.

The C1- to C20-alkyl acrylates and methacrylates, in particular C1- to C8-alkyl acrylates and methacrylates, vinylaromatics, in particular styrene, and mixtures thereof, in particular also mixtures of alkyl (meth)acrylates and vinylaromatics, are preferred as main monomers.

Methyl acrylate, methyl methacrylate, ethyl acrylate, n-butyl acrylate, n-hexyl acrylate, octyl acrylate and 2-ethylhexyl acrylate, styrene and mixtures of these monomers are very particularly preferred.

The polymer particles are preferably chemically crosslinked. For this purpose, monomers having at least two polymerizable groups, e.g. divinylbenzene or allyl methacrylate, can be concomitantly used (internal crosslinking). However, it is also possible to add crosslinking agents (external crosslinking).

Regarding the Matrix

There should be a difference in the refractive index between the matrix and the polymers.

The difference should preferably be at least 0.01, particularly preferably at least 0.1.

Either the matrix or the polymer may have the higher refractive index. What is decisive is that there is a difference.

The matrix consists of a deformable material. Deformable is understood as meaning that the matrix permits a spatial displacement of the discrete polymer particles on application of external forces (e.g. mechanical, electromagnetic).

The matrix therefore preferably consists of an organic material or organic compounds having a melting point or a glass transition temperature below 20° C., particularly preferably below 10° C., very particularly preferably below 0° C. (at 1 bar).

Organic compounds having a melting point or a glass transition temperature (Tg) above 20° C. are also suitable, but in this case temporary heating above the melting point or the Tg is required if the distances between the polymer particles are to be changed (see below).

Liquids, such as water, or more highly viscous liquids, such as glycerol or glycol, are suitable.

Polymeric compounds, e.g. polycondensates, polyadducts or polymers obtainable by free radical polymerization, are preferred.

Polyesters, polyamides, formaldehyde resins, such as melamine-, urea- or phenol-formaldehyde condensates, polyepoxides, polyurethanes or the abovementioned polymers which comprise the main monomers mentioned, e.g. polyacrylates, polybutadienes or styrene/butadiene copolymers, may be mentioned by way of example.

Regarding the Preparation

Preparation methods are described in DE-A 197 17 879 and DE-A 198 20 302.

Preparation of the Discrete Polymer Particles

The preparation of the polymer particles or polymers is effected in a preferred embodiment by emulsion polymerization, and said polymer particle or polymer is therefore an emulsion polymer.

The emulsion polymerization is preferred in particular because in this way, polymer particles having uniform spherical shape are obtainable.

However, the preparation can also be effected, for example, by solution polymerization and subsequent dispersing in water.

In the emulsion polymerization, ionic and/or nonionic emulsifiers and/or protective colloids or stabilizers are used as surface-active compounds.

A detailed description of suitable protective colloids is to be found in Houben-Weyl, Methoden der organischen Chemie, volume XIV/1, Makromolekulare Stoffe, Georg-Thieme-Verlag, Stuttgart, 1961, pages 411 to 420. Suitable emulsifiers are anionic, cationic and nonionic emulsifiers. Emulsifiers whose molecular weight, in contrast to the protective colloids, are usually below 2000 g/mol are preferably used.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

So-called reduction-oxidation (redox) initiator systems are also suitable.

The redox initiator systems consist of at least one generally inorganic reducing agent and one inorganic or organic oxidizing agent.

The oxidation component is, for example, one of the abovementioned initiators for the emulsion polymerization.

The reducing components are, for example, alkali metal salts of sulfurous acid, such as, for example, sodium sulfite or sodium hydrogen sulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems may be used with the concomitant use of soluble metal compounds whose metallic component may occur in a plurality of valency states.

Conventional redox initiator systems are, for example, ascorbic acid/iron(II) sulfate/sodium peroxodisulfate, tert-butyl hydroperoxide/sodium disulfite, tert-butyl hydroperoxide/sodium hydroxymethanesulfinic acid. The individual components, for example the reducing component, may also be mixtures, for example a mixture of the sodium salt of hydroxymethanesulfinic acid and sodium disulfite.

The amount of initiators is in general from 0.1 to 10% by weight, preferably from 0.5 to 5% by weight, based on the monomers to be polymerized. It is also possible to use a plurality of different initiators in the emulsion polymerization.

The emulsion polymerization is effected as a rule at from 30 to 130° C., preferably from 50 to 90° C. The polymerization medium may comprise either only water or mixtures of water and liquids miscible therewith, such as methanol. Preferably, only water is used. The emulsion polymerization can be carried out both as a batch process and in the form of a feed process, including a step or gradient procedure. The feed process is preferred, in which a part of the polymerization batch is initially taken, heated to the polymerization temperature and pre-polymerized and then the remainder of the polymerization batch is fed to the polymerization zone continuously, stepwise or with superposition of a concentration gradient while maintaining the polymerization, usually over a plurality of spatially separate feeds, one or more of which comprise the monomers in pure or in emulsified form. In the polymerization, it is also possible for a polymer seed to be initially taken, for example for better establishment of the particle size.

The manner in which the initiator is added to the polymerization vessel in the course of the free radical aqueous emulsion polymerization is known to the average person skilled in the art. It can either be initially taken completely in the polymerization vessel or used continuously or stepwise at the rate of its consumption in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

A uniform particle size distribution, i.e. a low polydispersity index, is obtainable by measures known to the person skilled in the art, for example by varying the amount of surface-active compound (emulsifier or protective colloid) and/or appropriate stirrer speeds.

For removing the residual monomers, initiator is usually added even after the end of the actual emulsion polymerization, i.e. after a monomer conversion of at least 95%.

In the feed process, the individual monomers can be added to the reactor from above, at the side or from below and through the bottom of the reactor.

In the emulsion polymerization, aqueous dispersions of the polymer, as a rule having solids contents of from 15 to 75% by weight, preferably from 40 to 75% by weight, are obtained.

Preparation of the Polymer Particle/Matrix (Layer) Mixture

Water or Solvent as Matrix

In the emulsion polymerization, an aqueous dispersion of the polymer particles is obtained directly. The water can easily be removed until the lattice structure of the polymer particles, detectable from the observable color effects, is established.

If other solvents are desired, water can be exchanged in a simple manner for these solvents.

Polymeric Compounds as Matrix

The aqueous dispersion of the discrete polymer particles which is obtained in the emulsion polymerization can be mixed with that amount of the polymeric compound which is required for establishing the lattice structure and the water then removed. Owing to the often high viscosity of the polymeric compound, it may be advantageous first to mix the polymer particles with the synthesis components of the polymeric compound and then after dispersing of the polymer particles is complete, to react these synthesis components, for example by condensation or adduct formation, to give the polymeric compounds.

However, it is also possible to use thermoplastic polymers as the matrix. Polymer particles and thermoplastic are mixed and are forced to crystallize by heat and shear forces, e.g. in an extruder. For establishing the melt properties, the polymer can be extruded and commercially available processing assistants can also be added.

Emulsion Polymers as Discrete Polymer Particles and Emulsion Polymers as the Matrix

Emulsion Polymers are Preferred as Discrete Polymer Particles and Emulsion Polymers as the Matrix

The corresponding emulsion polymers can be easily mixed and the water then removed. If the emulsion polymers for the matrix have a glass transition temperature below 20° C. (see above), the polymer particles form a film at room temperature and form the continuous matrix; at higher Tg, heating to temperatures above the Tg is required.

It is particularly simple and advantageous to prepare both emulsion polymers in one step as a core/shell polymer. For this purpose, the emulsion polymerization is carried out in 2 stages. First, the monomers which form the core (=subsequent discrete polymer particles) are polymerized and then the monomers which form the shell (=subsequent matrix) are polymerized in 2nd stage in the presence of the core.

During the subsequent removal of the water the soft shell, whose glass transition temperature is below 20° C., forms a film and the remaining (hard) cores are distributed as discrete polymer particles in the matrix.

The polymer particles are therefore particularly preferably the core of core/shell polymers, and the matrix is formed by film formation of the shell.

Core/shell polymers, obtainable by emulsion polymerization, are particularly preferred in the context of the present invention.

Particularly suitable embodiments of the core/shell emulsion polymers are to be found in DE-A 197 17 879, DE-A 198 20 302, DE-A 103 21 083, DE-A 103 21 079, DE-A 103 21 084 or in the German patent applications not yet published on the date of filing of this application and having the application numbers 10 2005 023 804.1, 10 2005 023 806.8, 10 2005 023 802.5 and 10 2005 023 807.6.

The weight ratio of core to shell is preferably from 0.05:1 to 20:1, particularly preferably from 0.1:1 to 1:1.

The polymeric compounds may also be crosslinked, so that they have elastic properties. If crosslinking is desired, it is preferably effected during or after the film formation, for example by a thermally or photochemically initiated crosslinking reaction of a crosslinking agent which is added or which may already be bonded to the polymer.

The crosslinking of the matrix results in a restoring force which acts on the discrete polymer particles. Without the action of external forces, the polymer particles then assume the pre-determined starting position again.

Regarding the structure of the polymer system comprising polymer particles and matrix

The polymer system results in an optical effect, i.e. an observable reflection due to interference of the light scattered by the polymer particles.

The wavelength of the reflection may be in the entire electromagnetic spectrum, depending on the spacing of the polymer particles. The wavelength is preferably in the UV range, IR range and in particular in the range of visible light.

According to the known Bragg equation, the wavelength of the observable reflection depends on the interplanar spacing, in this case the spacing between the polymer particles arranged in a space lattice structure in the matrix.

In order that the desired space lattice structure having the desired spacing between the polymer particles is established, in particular the proportion by weight of the matrix should be appropriately chosen. In the preparation methods described above, the organic compounds, e.g. polymeric compounds, should be used in an appropriate amount.

The proportion by weight of the matrix is in particular such that a space lattice structure of the polymer particles results, which structure reflects electromagnetic radiation in the desired range.

The spacing between the polymer particles (in each case up to the midpoint of the particles) is suitably from 50 to 1100 nanometers, preferably from 100 to 400 nm, if a color effect, i.e. a reflection in the range of visible light, is desired.

Regarding the Coated Substrate

The substrate may comprise any desired materials. For example, substrates comprising paper or plastic films are suitable, and in particular the substrate may also be a multi-layer laminate whose individual layers consist of different materials.

The thickness of the polymer layer applied to the substrate may be as desired, but a thickness of from 1 μm to 150 μm is generally sufficient for achieving good effects with sufficient intensity, but a thickness of up to several mm, for example up to 5 mm or more, can also be reached.

What is important is that the coated substrate overall has such little elasticity that, on elimination of the mechanical stress, the wavelength of the Bragg reflection remains unchanged compared with the starting state.

This can be achieved, for example, if the matrix material is chosen so that the restoring forces are only small. This can be achieved, for example, by the concomitant use of regulators in the polymerization of the shell of core/shell particles, the amount of regulator preferably being less than 10, particularly preferably less than 2, parts by weight per 100 parts by weight of monomers. In particular, this can also be achieved by concomitantly using only little or no crosslinking monomers or other crosslinking agents in the matrix or in the shell of the core/shell particles.

This can also be achieved if the substrate is less elastic than the polymer system; of course, on adhesion to the substrate material, the coated polymer system can return to the starting state only to the same extent as the substrate material itself.

If, for example, the Bragg reflection is in the visible wavelength range, the color changes compared with the original color after elimination of the mechanical stress.

A security feature designed in this manner, for example a label applied as a closure to a package is distinguished by a certain color which can be established by the polymer system according to the invention. If this security feature is stretched, for example by opening the package, an irreversible change in the color of the label occurs. It is thus possible to check in a simple manner whether the package was opened or not.

If the wavelength of the Bragg reflection is in the visible range the color change is observable compared with the starting state.

At wavelengths in the nonvisible range, i.e. IR or UV range, a wavelength change can then easily be detected by suitable detectors.

The coated substrates are suitable, for example, as labels, stickers, adhesive tape or adhesive film and can be adhesively bonded to any desired substrates.

In particular, the coated substrates can be used as or in packaging. They can be adhesively bonded as labels, stickers, adhesive tapes or adhesive films to a suitable point on any desired substrates; the packaging itself, however, may also partly or completely comprise the coated substrates.

The irreversible change in the wavelength of the Bragg reflection finally provides protection from copying or removal of characteristic features, such as trademarks, logos, product descriptions, etc., applied to packages.

When packages are opened or package components are removed, stresses occur at the relevant points. If the coated substrate is appropriately applied or is integrated into the packaging the coated substrate also stretches.

The coated substrates can also be used as forgery-proof markings. Such markings can be applied, for example, to bank notes, checks, credit cards, ID cards, stamps, lottery tickets, travel tickets, admission tickets, pharmaceutical packages, other packages, software, electronic articles, coding of trademarks, logos, articles of all kinds.

Since the wavelength of the Bragg reflection is no longer reversible or at least no longer completely reversible the wavelength of the Bragg reflection changes permanently. By simple determination of a color change or by use of suitable detectors (if the wavelength is in the IR or UV range), it is possible to determine whether the packages have already been opened or characteristic features have been removed or attempts have been made to make changes to markings.

### EXAMPLES

Preparation of the Polymers

The following working examples illustrate the invention. The emulsifiers used in the examples have the following compositions:

Emulsifier 1: 30% strength by weight solution of the sodium salt of an ethoxylated and sulfated nonylphenol having about 25 mol/mol of ethylene oxide units.

Emulsifier 2: 40% strength by weight solution of a sodium salt of a C12/C14-paraffinsulfonate.

Emulsifier 3: 15% strength by weight solution of linear sodium dodecylbenzenesulfonate.

The particle size distributions were determined with the aid of an analytical ultracentrifuge or with the aid of the capillary hydrodynamic fractionation method (CHDF 1100 particle size analyzer from Matec Applied Sciences) and the P.I. value was calculated from the values obtained according to the formula stated here

P.I.=(D90−D10)/D50.

Unless stated otherwise, solutions are aqueous solutions.

In the examples, pphm means parts by weight based on 100 parts by weight of total monomers.

The abbreviations used for monomers have the following meanings: AA=acrylic acid, n-BA=n-butyl acrylate, DVB=divinylbenzene, EA=ethyl acrylate, MAA=methacrylic acid, MAMol=N-methylolmethacrylamide, NaPS=sodium persulfate.

### Example 1

Preparation of an Emulsion Polymer

In a glass reactor provided with an anchor stirrer, thermometer, gas inlet tube, dropping funnel and reflux condenser, a dispersion of 0.9 g (0.20 pphm) of polystyrene seed (particle size: 30 nm) in 500 ml of water is initially taken and is heated in a heating bath with stirring, at the same time the air being displaced by passing in nitrogen. When the heating bath has reached the preset temperature of 85° C. and the reactor content has reached the temperature of 80° C., the introduction of nitrogen is stopped and an emulsion of 445.5 g of styrene (99.0% by weight), 4.5 g of divinylbenzene (1.0% by weight) and 14.5 g of emulsifier 1 (1.0 pphm) in 501.3 ml of water and 54.0 g of a 2.5% strength by weight aqueous solution of sodium persulfate (0.3 pphm) are added dropwise simultaneously in the course of 3 hours. After the solutions had been completely fed in, the polymerization is continued for a further 7 hours at 85° C. and then cooled to room temperature.

The dispersion has the following properties:

| | | |
|---|---|---|
| Solids content: | 29.6% | by weight |
| Particle size: | 255 | nm |
| Coagulum fraction: | <1 | g |

| | |
|---|---|
| pH: | 2.3 |
| Polydispersity index: | 0.13 |
| Refractive index: | 1.59 |

This example was repeated several times, the concentration of the seed particles being varied. The following table 1 gives an overview of the experimental results obtained.

TABLE 1

| | Example Number | | | | | | |
|---|---|---|---|---|---|---|---|
| | 1A | 1B | 1C | 1D | 1E | 1F | 1G |
| Seed conc. | 0.20 | 0.15 | 0.10 | 0.053 | 0.30 | 0.53 | 3.16 |
| % by weight | | | | | | | |
| Solids content | 28.8 | 28.4 | 28.5 | 29.4 | 29.3 | 30.0 | 28.6 |
| % by weight | | | | | | | |
| Particle size | 256 | 280 | 317 | 357 | 222 | 188 | 125 |
| [nm] | | | | | | | |
| P.I. | 0.13 | — | — | 0.19 | — | — | 0.221 |

### Example 2

Preparation of an Emulsion Polymer Having a Core/Shell Construction

In a glass reactor provided with an anchor stirrer, thermometer, gas inlet tube, dropping funnel and reflux condenser, 300 g of the dispersion of core particles obtained in example 1A are initially taken and are heated in a heating bath with stirring, at the same time the air being displaced by passing in nitrogen.

When the heating bath has reached the preset temperature of 85° C. and the reactor content has reached the temperature of 80° C., the introduction of nitrogen is stopped and
a) a mixture of 85.1 g (98.5% by weight) of n-butyl acrylate, 0.86 g (1.0% by weight) of acrylic acid, 0.43 g (0.5% by weight) of tert-dodecyl mercaptan, 2.86 g of a 31% strength by weight solution (0.97 pphm) of emulsifier 1 and 12.4 g of water and
b) 17.3 g of a 2.5% strength by weight aqueous solution of sodium persulfate (0.5 pphm)
   are simultaneously added dropwise in the course of 1.5 hours.

After the solutions had been completely fed in, the polymerization is continued for a further 3 hours at 85° C. Thereafter, the dispersion of core/shell particles obtained is cooled to room temperature.

The dispersion has the following properties:

| | | |
|---|---|---|
| Solids content: | 40.6% | by weight |
| Particle size: | 307 | nm |

| | |
|---|---|
| Polydispersity index (PI): | 0.16 |
| Weight ratio core:shell: | 1:1 (calculated) |
| Refractive index of the shell polymer: | 1.44 |

This example was repeated twice, the concentration of the core particle and the weight ratio of core/shell being varied. The following table 2 gives an overview of the experimental results obtained.

TABLE 2

| | Example Number | | |
|---|---|---|---|
| | 2A | 2B | 2C |
| Shell fraction | 100.0 | 133.3 | 225.0 |
| (parts by weight) | | | |
| n-BA [% by weight] | 98.5 | 98.5 | 98.5 |
| AA [% by weight] | 1.0 | 1.0 | 1.0 |
| tert-Dodecyl mercaptan | 0.5 | 0.5 | 0.5 |
| Core:shell ratio | 1:1 | 0.75:1 | 0.44:1 |
| Particle size [nm] | 301 | 312 | 329 |
| P.I. | 0.151 | 0.169 | 0.174 |
| Solids content [% by | 39.9 | 40.9 | 41.2 |
| weight] | | | |

% by weight for n-BA, tert-dodecyl mercaptan and AA are based on the shell.

Production of a Reflecting Layer

### Example 3A

15 g of the dispersion obtained according to example 2A are dried in a silicone rubber dish at room temperature. A layer giving a luminescent effect color and having rubber-like elasticity is obtained. The transparent film obtained has a luminescent color changing with the angle of illumination and angle of view, the color intensity being more strongly visible the darker the background. On stretching of the layer, its color changes irreversibly with the stretching ratio from red brown through green to violet and up to ultraviolet.

### Examples 3B and 3C

The procedure is as in example 3A, except that the dispersion from 2B or 2C is used instead of the dispersion from example 2A. The transparent film obtained has a luminescent color changing with the angle of illumination and angle of view, the color intensity being more strongly visible the darker the background. On stretching of the layer thus obtained its color changes irreversibly from a red in example 3B or a dark red in example 3C through green to violet and up to ultraviolet.

1. A substrate coated with a polymer system, wherein
the polymer system exhibits electromagnetic radiation reflection said reflection is Bragg reflection,
when the polymer system is under a strain produced by a mechanical stress, a wavelength of the reflection is variable, and
the coated substrate as a whole has such little elasticity that, on elimination of the mechanical stress, the wavelength of the Bragg reflection is changed compared with a starting state.

2. The coated substrate according to claim 1, wherein the polymer system comprises polymer particles and a deformable matrix, the polymer particles distributed in the deformable matrix according to a defined space lattice structure.

3. The coated substrate according to claim 2, wherein the polymer particles comprise one or more particle types having a median particle diameter in the range from 0.05 to 5 μm, each particle type having a polydispersity index (PI) of less than 0.6, calculated according to formula (I):
P.I.=(D90−D10) (I)
wherein D90, D10 and D50 are particle diameters for which the following is true:
D90: 90% by weight of the total mass of all particles has a particle diameter less than or equal to D90;
D50: 50% by weight of the total mass of all particles has a particle diameter less than or equal to D50; and
D10: 10% by weight of the total mass of all particles has a particle diameter less than or equal to D10.

4. The coated substrate according to claim 2, wherein the polymer particles have a glass transition temperature greater than 30° C.

5. The coated substrate according to claim 2, wherein the polymer particles and the matrix differ in refractive index.

6. The coated substrate according to claim 2, wherein the matrix consists of a polymeric compound.

7. The coated substrate according to claim 2, wherein the polymer particles are the core of core/shell polymers and the matrix is formed by film formation of the shell.

8. The coated substrate according to claim 2, wherein a distance between the polymer particles is from 50 to 1100 nanometers, so that electromagnetic radiation in a range from ultraviolet to near infrared light is reflected.

9. The coated substrate according to claim 2, wherein a distance between the polymer particles is from 100 to 400 nanometers, so that electromagnetic radiation in a range of visible light is reflected.

10. The coated substrate according to claim 1, wherein a thickness of a layer is from 1 μm to 150 μm.

11. The coated substrate according to claim 1, wherein the substrate is selected from the group consisting of paper, cardboard, a plastic film, and a metal foil.

12. The coated substrate according to claim 1, which is in the form of a label sticker adhesive tape or an adhesive film.

13. A packaging comprising the coated substrate according to claim 1.

14. A method of protecting a characteristic feature of a packaging comprising applying the coated substrate according to claim 1 onto said packaging.

15. A method of identifying a used or opened packaging comprising the coated substrate according to claim 1, said method comprising detecting an irreversible change in Bragg reflection of the substrate.

16. The coated substrate according to claim 1, which is in the form of a forgery-proof marking.

17. (canceled)

18. A banknote, check, credit card, ID card, stamp, lottery ticket, travel ticket, admission ticket, pharmaceutical packaging, general packaging, software, electronic article, coding of a trademark, logo, or an article of another kind comprising the forgery-proof marking according to claim 16.

19. The coated substrate according to claim 2, wherein the matrix comprises a polymeric compound.

20. A substrate coated with a polymer system, wherein
(1) said polymer system exhibits Bragg reflection at at least one wavelength of electromagnetic radiation prior to any elongation of said substrate;
(2) said at least one wavelength at which said Bragg reflection is exhibited changes in response to elongation of said substrate; and
(3) the coated substrate as a whole has such little elasticity that, upon elongation, the wavelength of the Bragg reflection is changed compared with the a starting state.
